(19) United States
(12) Patent Application Publication
(10) Pub. No.: US 2019/0320644 A1
(43) Pub. Date: Oct. 24, 2019

(54) RODENT BOX

(71) Applicant: SMAM LTD, Surrey, Guildford (GB)

(72) Inventor: Stephen GOULD, Pickering (GB)

(73) Assignee: SMAM Ltd, Surrey, Guildford (GB)

(21) Appl. No.: 16/310,374

(22) PCT Filed: Jun. 16, 2017
(86) PCT No.: PCT/GB2017/051758

§ 371 Date: Dec. 14, 2018

(30) Foreign Application Priority Data
Jun. 17, 2016 (GB) 1610567.8

(51) Int. Cl. A01M 25/00; A01M 23/16

(52) U.S. Cl. CPC A01M 25/004; A01M 23/16

(57) ABSTRACT

A rodent box comprising a chamber having at least one side wall, wherein the side wall comprises an aperture to allow access into the chamber and wherein the box is provided with a spacer section extending in a direction away from the chamber.

### FIELD OF THE INVENTION

The invention relates to a device for catching rodents or monitoring rodent activity, particularly to a rodent box suitable for catching rats.

### BACKGROUND TO THE INVENTION

Rodents, particularly rats, are often considered to be a pest due to the damage that they cause, along with the risk of disease associated with them.

Rodenticides (referred to in the art as “bait”) are often employed to poison the rodents, which has a poisonous active ingredient. The bait may be left out for rodents to consume. However, there are risks associated with this practice, particularly because the bait can be poisonous to humans, pets, wildlife and livestock. Children, pets and non-target wildlife species have been known to find bait and to touch it and/or consume it, causing health problems and, in some cases, death. Therefore, there is a reluctance to employ rodenticide where children, pets, wildlife and livestock can access it. Additionally, there are restrictions on the use of rodenticide in some territories.

Hitherto known traps are often put in places where rats are known to be. However, this often proves to be ineffective because rats are neophobic in respect of food and environment, that is, they do not like strange objects or new food appearing in their familiar environment. This means that where a trap is put down, the rat is extremely wary of it and will often stay away from the trap, particularly where the trap interrupts a known thoroughfare.

### SUMMARY OF THE INVENTION

According to the present invention there is provided an apparatus and method as set forth in the appended claims. Other features of the invention will be apparent from the dependent claims, and the description which follows.

Accordingly, a first aspect of the present invention is directed to a rodent box comprising a chamber having at least one wall, wherein the wall comprises an aperture to allow access into the chamber and wherein the box is provided with a spacer section extending in a direction away from the chamber.

The provision of a spacer allows for the device to be readily positioned against a wall but with a gap between the entrance to the box (i.e. the aperture) and the wall, thereby defining a channel. As rats are known to stay close to walls when travelling and they are wary of items placed in familiar thoroughfares, the present invention allows for the familiar thoroughfare to remain accessible to the rat, by having a spacer to keep the box away from the wall. This provides a rodent box that allows a rat to walk along the wall uninterrupted and so it is more successful in trapping a rat because the rat is not scared away by a change in the contours of the wall or blockage. The rodent walks along the wall as normal and then detects bait within the box and enters through the aperture.

The box may be used to house bait (i.e. rodenticide) and/or traps to retain the rodent within the box.

It is preferable that the spacer comprises at least one section extending outwardly from the wall of the box, which may be planar. Having a planar spacer allows for an arm or flat section to be positioned between the chamber and the wall to keep a channel open against the wall along which the rodent can travel. A spacer section allows for a tunnel or channel to be formed therebeneath, thus allowing rodents to walk underneath the spacer and adjacent the rodent box. The spacer section may create the channel adjacent the at least one wall of the chamber, so as to allow a rodent to approach and enter the rodent box from a non-perpendicular direction relative to the at least one side wall

Advantageously, the spacer is integral with a wall of the rodent box and extends therefrom. Whilst the spacer may be detachable from the chamber, having it integral with the chamber reduces the risk of it being incorrectly employed, lost or damaged. Furthermore, it ensures that the spacer is arranged at the correct position and is the correct size.

The area extending from an edge of the spacer distal from the chamber may be at least partially vacant of material in a direction parallel with the at least one wall. In one arrangement, the spacer is provided with a leg section extending in a downwards direction. Providing a downwardly extending leg provides some rigidity to the spacer and reduces the risk of the spacer breaking. The leg section may be disposed opposite the aperture, preferably on an opposite side of the spacer to the aperture, preferably so that the channel is between the aperture and the leg section. The leg section may comprise a first section extending downwardly from the spacer to the floor. The leg section may comprise a second, horizontal section extending substantially horizontally to the chamber, preferably from the first section. The first section may be inclined with respect to a vertical plane. The first section may comprise flanges, which may be strengthening flanges. Whilst the leg section may be distal from the chamber by creating it as a thin, planar structure, it does not significantly affect the contour of the wall and the rodents are not alerted by its presence.

Preferably, the chamber is a box comprising a floor, a front wall, a rear wall and two side walls and the spacer comprises an upper section and a lower section, the upper section being an enclosure extending from both ends of the box in a direction away from the front wall and the lower section of the spacer comprises at least one leg. Having an extending section that extends from the sides of the box away from the chamber allows for a solid and robust spacer to be created. The lower part is open to allow the rodents to pass through as normally, save for one or more leg sections that support the box and spacer and keep it balanced. The floor may be omitted in some embodiments, wherein the box is placed directly onto a floor with the traps or bait contained within the rodent box, when in place.

It is advantageous that the chamber comprises a removable lid, which may be pivotable or completely detachable. The lid may be hingedly connected to the box, preferably by a living hinge. The use of a lid allows a user to readily access the inside of the chamber or box in order to check the traps or bait therein without having to disturb the rodent box too much.

In one arrangement, at least one internal guard wall is positioned adjacent the aperture and within the chamber. The use of one or more internal guard walls reduces the risk of a person putting their hand into the box and disturbing bait and/or traps. The internal wall(s) may be part of a tortuous path that allows a rodent into the box but reduces the risk of a human interfering with the internal section of the box via the aperture.

The rodent box may be formed partially or entirely from plastic material.

The rodent box may comprise at least one non-target species deterrent. The at least one non-target species deterrent may be positioned to extend into the channel formed by the chamber and spacer, preferably from the spacer. Alternatively, the non-target species deterrent may extend from the internal wall. The rodent box may comprise a pair of non-target species deterrents, each arranged proximate to a respective entrance of the channel. The non-target species deterrent may comprise a projection, preferably a flexible projection, arranged to flex to allow passage of a target rodent species.

A second aspect of the invention extends to a method of installing a rodent box, wherein the method includes the steps of supplying a rodent box as described herein and positioning the spacer against a wall or floor of a building so that the aperture to the chamber faces the wall or floor of the building and is spaced away from the wall or floor thereof.

The box may be installed substantially vertically, that is with the chamber extended in a substantially upward or downward direction relative to the wall or floor, or substantially horizontally, that is with the chamber sitting on the floor. The desired installation orientation will depend upon the requirements.

Further preferred features of the second aspect are defined hereinabove in respect of the rodent box of the first aspect, and may be combined in any combination.

### BRIEF DESCRIPTION OF THE DRAWINGS

For a better understanding of the invention, and to show how embodiments of the same may be carried into effect, reference will now be made, by way of example only, to the accompanying diagrammatic drawings in which:

FIG. 1 is a perspective view of a rodent box according to an example of the present invention;

FIG. 2 is a front view of the rodent box of FIG. 1;

FIG. 3 is a side view of the rodent box of FIG. 1;

FIG. 4 is a further perspective view of the rodent box of FIG. 1 with a lid removed;

FIG. 5 is a top view of the rodent box of FIG. 1 with a lid removed;

FIG. 6 is a partial cut-away view of a further rodent box according to an example of the present invention;

FIG. 7 is a further view of the rodent box of FIG. 6;

FIG. 8 is a view of another rodent box according to an example of the present invention;

FIG. 9 is cut-away bottom view of the exemplary rodent box of FIG. 8;

FIG. 10 is a rear view of the exemplary rodent box of FIG. 8;

FIG. 11 is a perspective view of a rodent box according to a further example of the present invention;

FIG. 12 is a perspective view of the rodent box of FIG. 11 in an open configuration;

FIG. 13 is a front perspective view of the rodent box of FIG. 11, and

FIG. 14 is a side plan view of the rodent box of FIG. 11.

In the drawings, corresponding reference characters indicate corresponding components. The skilled person will appreciate that elements in the figures are illustrated for simplicity and clarity and have not necessarily been drawn to scale. For example, the dimensions of some of the elements in the figures may be exaggerated relative to other elements to help to improve understanding of various example embodiments. Also, common but well-understood elements that are useful or necessary in a commercially feasible embodiment are often not depicted in order to facilitate a less obstructed view of these various example embodiments.

### DESCRIPTION

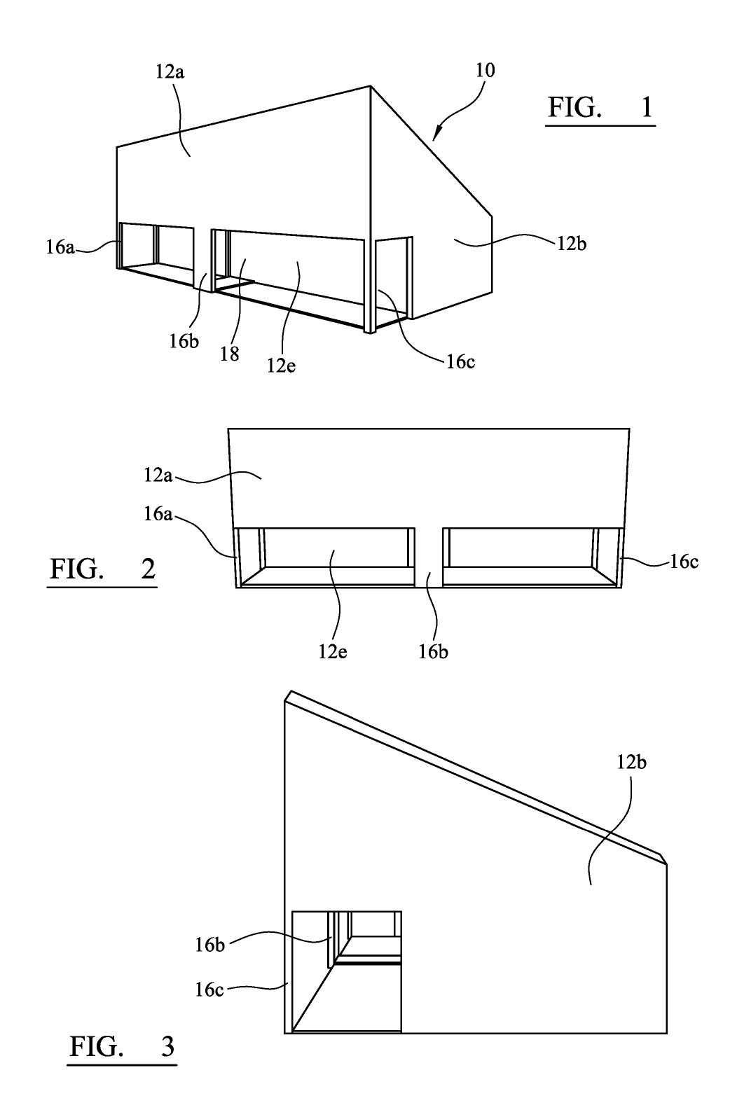

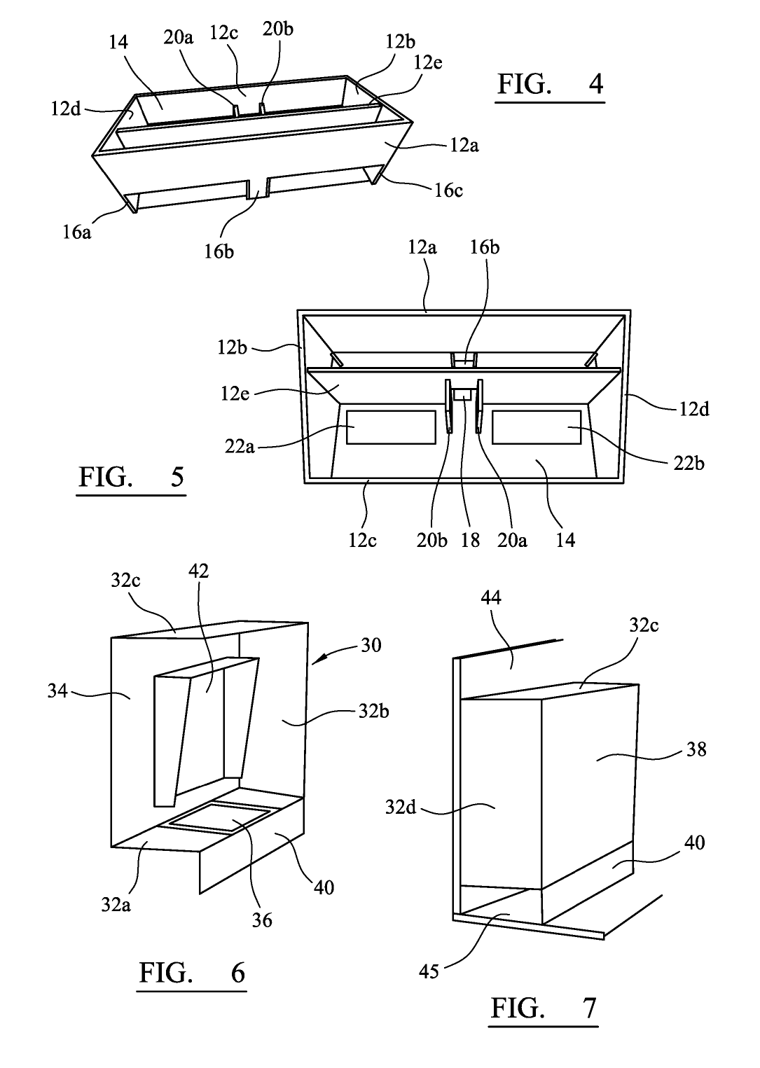

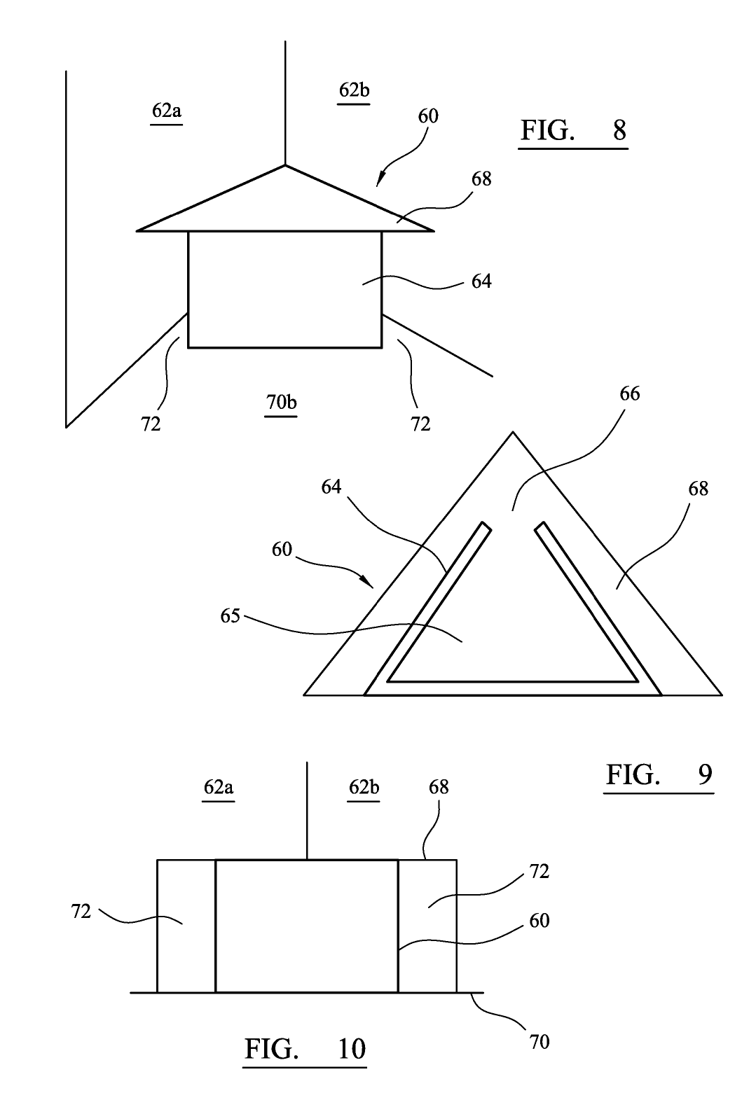

FIGS. 1 to 5 show an exemplary rodent box 10. The rodent box 10 comprises front wall 12a, rear wall 12c and side walls 12b and 12d, with an internal wall 12e extending between the two opposing side walls 12b and 12d and parallel with the front wall 12a and rear wall 12c to form a main chamber 14 between the internal wall 12e and the rear wall 12c.

The top of front wall 12a is higher than the top of rear wall 12c such that the sidewalls 12b and 12d are trapezoid in shape. The upper part of front wall 12a is solid and the lower part of front wall 12a is open with legs 16a to 16c extending from the lower edge of the upper part of the front wall 12a to the base of the rodent box 10. The front section between the front wall 12a and the internal wall 12e creates a spacer that allows rodents to pass between the rodent box 10 and the internal wall 12e when the front wall 12a is positioned against a wall of a building.

Internal wall 12e is provided with an aperture 18 therein to allow access into the main chamber 14. The spacer prevents the rodent box 10 from being positioned with the aperture 18 too close to the wall thereby blocking access to the main chamber 14. Adjacent the aperture 18 and internal to the main chamber 14 are two guard walls 20a and 20b extending towards, but not reaching to, the rear wall 12c. Two traps 22a and 22b are positioned between the guard walls 20a and 20b and the side walls, 12b and 12d, respectively.

In one example, the traps 22a/b comprise mechanical traps, for example using a spring mechanism that, when triggered, kills the rodent. Alternatively, the traps 22a/b comprise rodenticide (or “bait”) or glue traps. It will be understood that the particular type of trap employed will be varied according to the particular use of the rodent box 10, and that the rodent box 10 may comprise a combination of different trap types.

A lid (not shown) is provided to protect the internal chamber 14 and to prevent objects from entering the rodent box 10 through the top of the device. The lid may be releasably retained on the rodent box 10 and, optionally, may include a locking mechanism.

In use, a location where rodents are known or suspected to be present is identified and the rodent box 10 is positioned against a wall of a building such that the front wall 12a is against the building wall with the lower part of the front wall 12a adjacent the floor of the building. Due to the open face of the lower part front wall 12a, the building wall is still visible to the internal wall 12e and aperture 18 therein. Legs 16a and 16c, which are distal from the aperture 18, are narrow such that they do not have a large profile when adjacent the building wall. Bait is positioned in the traps 22.

As the rodents walk along the building wall, the rodents stay close to the wall and the familiar surroundings. The rodents pass the legs 16a and 16c and continue towards the central leg 16b, at which point they will be able to detect bait that is on the traps 22 within the main chamber 14. The rodents are attracted to the bait on the traps 22 and pass through the aperture 18 to reach it. The rodent passes between guard walls 20 and to the traps 22 within the internal chamber 14 and are thereafter caught in the box 10. The guard walls 20 prevent a person reaching into the traps 22 and touching the bait on the traps 22 when the lid is on. The guard walls 20 also help to improve the rigidity of the rodent box 10.

In some embodiments, the distal legs 16a and 16c may be omitted and a single leg may be employed.

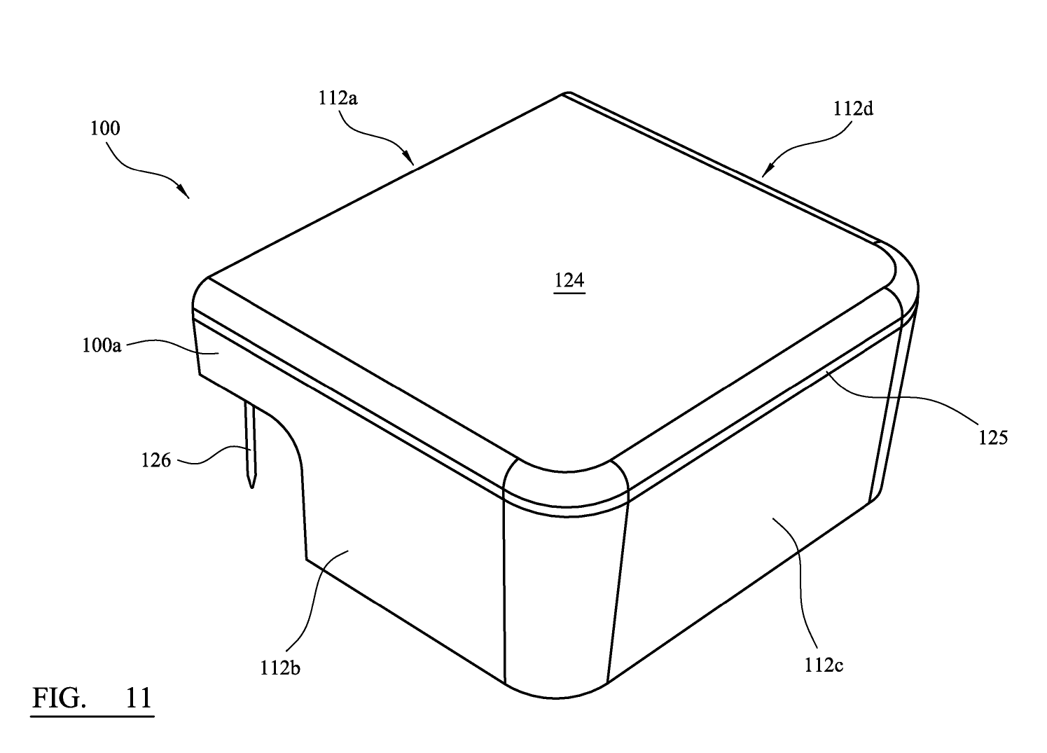

FIGS. 6 and 7, show a rodent box 30 according to a further example of the invention. The rodent box 30 may be installed in a substantially vertical position. In such an arrangement, the device comprises a front wall 32a arranged to face the floor 45, a rear wall 32c and two side walls 32b and 32d, creating a main chamber 34 therewithin. The front wall 32a is provided with an aperture 36 therein the allow access to the main chamber 34. The rodent box 30 is further provided with a base (not visible) and a top section 38. The top section 38 of the rodent box 30 extends beyond the front wall 32a and over the aperture 36 to create a spacer 40. A trap 42 is positioned within the main chamber 34.

To install the device, the leading edge of the spacer 40, that is the edge distal from the main chamber 34, is positioned on a surface and the base is attached to a wall 44. Accordingly, the front wall 32a faces the floor 45, thereby defining a channel formed by the front wall 32a, the spacer 40, the wall 44 and the floor 45. The contour of the wall 44 is unchanged, thereby reducing the risk of a rodent being scared off and the aperture 36 faces the ground, thus allowing the rodent to climb up and enter the main chamber 34. Part of the device 30 may be detached to allow access to the main chamber 34, for example, the top section 38 may be releasably attached to the walls 32. This allows the trap 42 to be baited and cleared, when required.

The rodent box 30 may also be used in a horizontal arrangement where there is a desire to employ a spacer without the use of legs 16, thereby reducing the profile of the box against the wall.

The spacer may comprise a directing wall extending from the spacer towards the aperture. This directing wall may be employed to help to direct the rodent towards the opening in the chamber, thereby leading the rodent into the box.

FIGS. 8 to 10 show a rodent box 60 in accordance with a further example of the invention. The box 60 is angled so that, for example, it can be positioned into a corner with the box being adjacent two walls 62a and 62b. The box 60 comprises a triangular side wall 64 with an opening 66 therein, the opening 66 being adjacent a corner of the box 60. The inside of the triangular side walls 64 constitutes a chamber 65. A spacer section 68 in the form of overhanging roof is provided along at least the two sides that converge at the opening 66. A trap or bait (not shown) is positionable within the chamber 65 so that rodents are lured into the box 60. In use, the box 60 is placed on the ground 70 the spacer 68 is positioned against the walls 62 with the opening 66 closest to the corner. This allows the box 60 to be employed in the corner of a room whilst maintaining channels 72 on either side that allow the rodents to keep close to the walls 62a and 62b.

FIGS. 11 to 14 show a rodent box 100 in accordance with a further example of the invention. The box 100 comprises a front wall 112a, rear wall 112c disposed substantially opposite the front wall 112a, and side walls 112b/d.

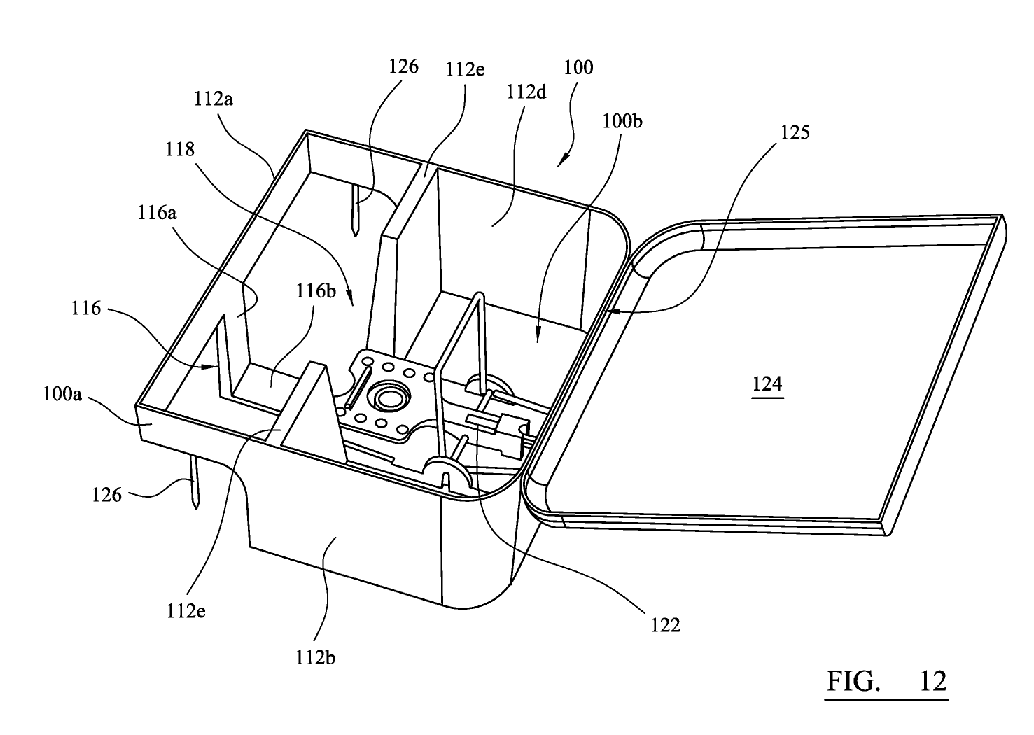

As can be best seen in FIG. 12, the box 100 further comprises an internal wall 112e. The internal wall 112e, side walls 112b/d and rear wall 112c define a chamber 100b in which a trap 122 is disposed. The internal wall 112e is disposed in a plane substantially parallel to the plane of the front wall 112a. The internal wall 112e is positioned behind the front wall 112a—in other words the distance between the internal wall 112e and the rear wall 112c is smaller than the distance between the front wall 112a and the rear wall 112c. Accordingly, the front wall 112a and internal wall 112e have a stepped configuration when viewed from the side, as can be best seen in FIG. 14.

Once the front wall 112a is disposed against a wall (not shown), the internal wall 112e faces the wall but is spaced therefrom by the front wall 112a and a front portion 100a of the box 100 extending forward of the internal wall 112e and away from the chamber 100b, which accordingly acts as a spacer. The front portion 100a defines a channel thereunder, through which rodents can pass whilst remaining substantially in contact with the wall.

The internal wall 112e comprises an aperture 118 formed therein, which permits ingress of the rodent to the chamber 100b, so that it can access the trap 112.

In one example, the box 100 further comprises a leg 116 arranged to support the front portion 100a. The leg 116 comprises a substantially vertical portion 116a extending downward from the lower edge of the front wall 112a, and a substantially horizontal portion 116b extending orthogonally from the lower edge of the vertical portion 116a to the base of the internal wall 112e. The leg 116 may be disposed facing the aperture.

As can be best seen in FIGS. 12-14 the leg 116 is relatively thin. Particularly, the vertical portion 116a is thin in its extent from the plane of the front wall 112a towards the rear wall 112c. For example, it may measure approximately 5-10 mm, preferably approximately 7 mm, at its thickest point. The leg 116 is also thin in its extent in a plane from one side wall 112b to the other side wall 112d, i.e. in a direction parallel to the internal wall 112e. For example, the leg 116 may be approximately 10-30 mm, preferably approximately 20 mm, wide in this direction. In addition the horizontal portion 116a has minimal depth. In one example, it is under 5 mm deep, preferably approximately 2 mm deep.

In one example, the vertical portion 116a extends approximately 70 mm from the lower edge of the front wall 112a to the point at which it meets the horizontal portion 116b. In one example, the horizontal portion 116b extends approximately 70 mm from the lower edge of the internal wall 112e to the point at which it meets the vertical portion 116a.

Accordingly, the leg 116 is arranged so that it minimally interferes with the passage of the rodent along the wall/floor. The leg 116 is provided to give structural rigidity to the front wall 112a, which would otherwise only be supported by the side walls 112b/d.

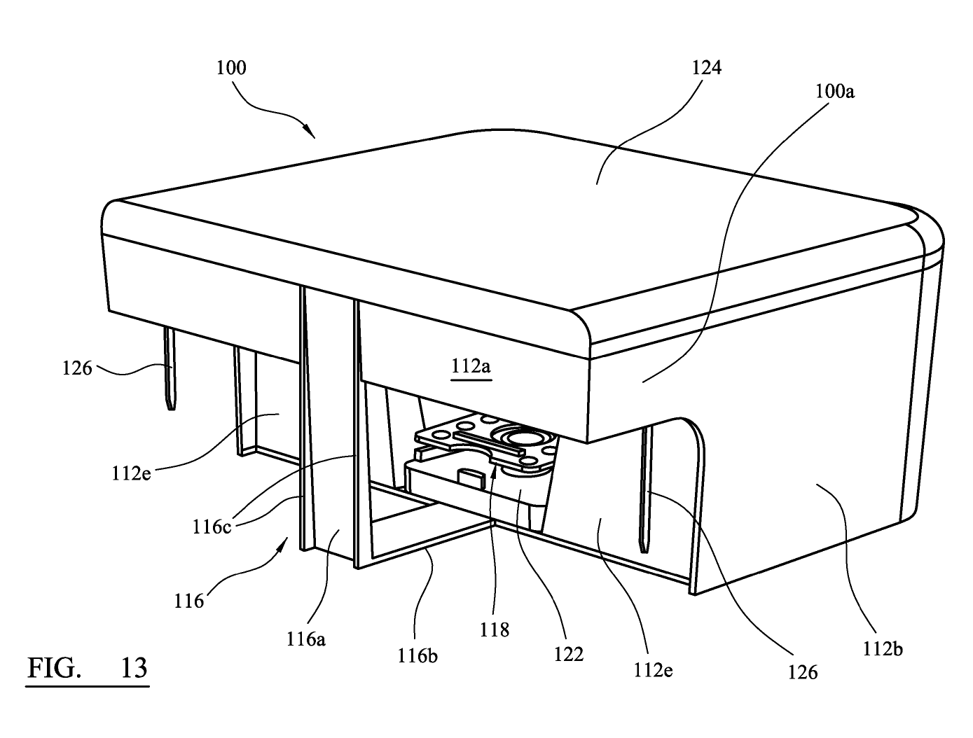

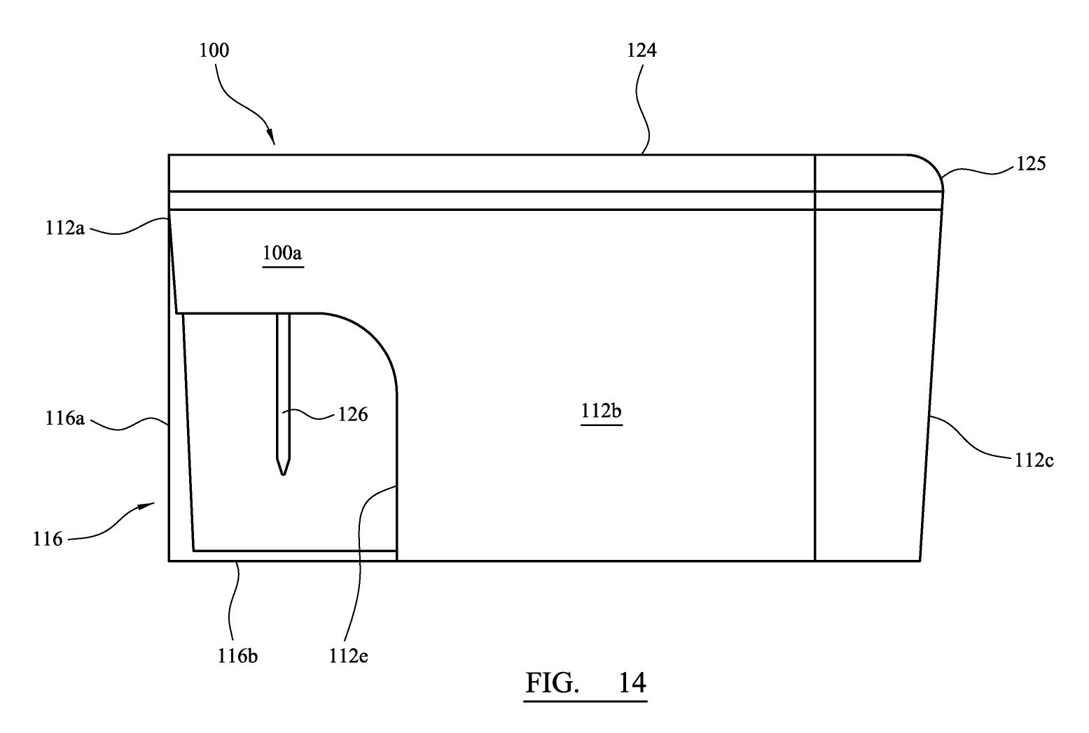

As can be best seen in FIG. 13, flanges 116c extend from the peripheral vertical edges of the vertical portion 116a. The flanges 116c give structural stability to the leg 116, whilst minimizing the weight and volume thereof. In addition, the flanges 116c increase in depth as they extend from top to bottom, therefore giving the interior surface of the vertical portion 116a a slight inclination, as can be seen in FIG. 14.

The box further comprises a lid 124, extending over the chamber 100b and front portion 100a, so as to enclose the chamber. In one example, the lid 124 is hingedly connected the box 100, for example by virtue of a hinge 125 disposed on the upper edge of the rear wall 112c. Accordingly, the lid 124 is pivotable between a closed position (as seen in FIGS. 11, 13 and 14) and an open position (FIG. 12).

In one example, the box 100 comprises one or more non-target species deterrents 126. The deterrents 126 are arranged to deter species other than the target rodents from entering the chamber 100b and contacting the trap 122. Particularly, the deterrents 126 are positioned so as to extend from the box 100 into the channel under the front portion 100a, thereby dissuading the non-target species from entering the channel. As best seen in FIG. 12, one deterrent 126 may be disposed at either end of the channel, proximate the entrance thereto.

In one example, the deterrents 126 take the form of a flexible spike. When a target rodent attempts to enter the channel, the deterrent 126 flexes, allowing the rodent to pass. However, when a non-target species (e.g. a bird or a small domestic animal) attempts to enter the channel, it is deterred from entry. In one example, each deterrent 126 extends vertically downwards from the underside of a respective sidewall 112b, 112c in the front portion 100a of the box 100. It will be understood that the deterrents could instead extend into the channel from the internal wall 112e.

In one example, the box 100 is formed of plastic. In such an example, the hinge 125 may take the form of a living hinge—i.e. a hinge that is formed a thinner portion of the same material as the remainder of the box 100. In such an example, the box 100 may be advantageously formed entirely of plastic. In further examples, the box 100 may be formed fully or partly from metal.

Various adaptations and modifications are possible to the examples described herein. It is explicitly envisaged that the features of the various examples may be combined. For example, the deterrents 126 may be incorporated into the boxes 10, 30, 60. The walls 20a/b may be incorporated into the boxes 30, 60, 100. The box 60 may be configured to fit in corners of varying angles. Each of the boxes may be made of plastic, metal or a combination thereof. Each box 10, 30, 60, 100 may be modified to include more or fewer traps—for example 1, 2, 3 or 4 traps. Each box 10, 30, 60, 100 may be modified to include a combination of different types of traps.

Advantageously, the rodent boxes described herein can be conveniently positioned proximate a wall or floor so that a channel is defined by the wall/floor and box so as to capture rodents passing along the wall/floor. Furthermore, the box minimally interferes with the wall/floor, for example by only comprising a single, thin support leg. Advantageously, this allows the rodent to pass along the wall/floor whilst being minimally disturbed by the box, thus preventing the rodent's neophobic instincts from being activated. Accordingly, the boxes are more efficacious, as fewer rodents are scared away therefrom.

Furthermore, the rodent boxes described herein advantageously reduce the likelihood that other, non-target, species from entering the box, both by virtue of the positioning of the aperture facing the wall/floor and by means of deterrents.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiments. The invention extends to any novel one, or any novel combination, of the features disclosed in this specification (including any accompanying claims, abstract and drawings), or to any novel one, or any novel combination, of the steps of any method or process so disclosed.

1. A rodent box comprising:
a chamber having at least one wall, wherein the at least one wall includes an aperture to allow access into the chamber;
a spacer that extends in a direction away from the chamber and includes a front wall configured to be disposed against a structure wall or floor in which the rodent box is adjacent, the front wall being disposed in a plane substantially parallel to the plane of the at least one wall of the chamber that includes the aperture; and
a channel defined between the chamber, the spacer and the structure wall or floor when the rodent box is positioned adjacent the structure wall or floor.

2. A rodent box according to claim 1, wherein the spacer comprises at least one planar section extending outwardly from the at least one wall of the chamber.

3. A rodent box according to claim 2, wherein the spacer is integral with the chamber.

4. A rodent box according to claim 1, wherein the spacer is provided with a leg section extending downwards so as to be adjacent to the channel.

5. A rodent box according to claim 4, wherein the leg section is disposed on a side of the spacer opposite a side in which the at least one wall of the chamber that includes the aperture is located.

6. A rodent box according to claim 4, wherein the leg section comprises a horizontal section extending to the chamber.

7. (canceled)

8. A rodent box according to claim 1, wherein the chamber comprises a removable lid.

9. A rodent box according to claim 1, wherein at least one guard wall is positioned adjacent the aperture and within the chamber.

10. A rodent box according to claim 1, comprising a non-target species deterrent extending into the channel.

11. A rodent box according to claim 10, comprising a pair of non-target species deterrents, each arranged proximate to a respective entrance of the channel.

12. A rodent box according to claim 10, wherein the non-target species deterrent comprises a projection.

13. A rodent box according to claim 12, wherein the projection is a flexible projection arranged to flex to allow passage of a target rodent species.

14. A rodent box according to claim 1, wherein the rodent box is configured to be attachable to the structure wall, and wherein the spacer is configured to space the chamber from the structure floor.

15. A rodent box according to claim 1, further comprising;
a trap within the chamber.

16. A method of installing a rodent box, the method comprising:
Supplying the rodent box having a chamber with an aperture to allow access into the chamber, a spacer with a front wall distant from and substantially parallel to the chamber, and a channel formed by the chamber and spacer; and
positioning the spacer against a wall or floor of a building so that the aperture of the chamber faces the wall or floor of the building and is spaced away from the wall or floor of the building.

17. A rodent box according to claim 3, wherein the chamber is a box comprising a floor, two ends and two side walls and the spacer comprises an upper section and a lower section, the upper section being an enclosure extending from both ends of the box in a direction away from a side wall and the lower section of the spacer comprises at least one leg.
